(19) United States
(12) Patent Application Publication
(10) Pub. No.: US 2015/0247716 A1
(43) Pub. Date: Sep. 3, 2015

(54) TAPE MEASURE

(71) Applicant: Irwin Industrial Tool Company, Huntersville, NC (US)

(72) Inventors: William Craig, Indian Trail, NC (US); Matthew Justin Paquette, Charlotte, NC (US); David P. Engvall, Stanley, NC (US); Douglas Johnson, Belmont, NC (US)

(21) Appl. No.: 14/630,881

(22) Filed: Feb. 25, 2015

Related U.S. Application Data
(60) Provisional application No. 61/946,223, filed on Feb. 28, 2014.

(51) Int. Cl. G01B 3/10

(52) U.S. Cl. CPC G01B 3/1005; G01B 3/1041; G01B 3/1056; G01B 2003/1007

(57) ABSTRACT

A tape measure has a housing and a blade retractably mounted in the housing such that an end of the blade may be extended from the housing. The blade may have a profile with a sinusoidal shape. A reinforcement member may be attached to the blade over a length of the blade. The sinusoidal shape or the reinforcement member extends from the end of the blade for a predetermined distance. The sinusoidal shape or the reinforcement member may be provided from a point along the blade spaced from the end of the blade and a second point along the length of the blade.

This application claims benefit of priority under 35 U.S.C. §119(e) to the filing date of U.S. Provisional Application No. 61/946,223, as filed on Feb. 28, 2014, which is incorporated herein by reference in its entirety.

### BACKGROUND

A typical tape measure comprises a housing for receiving a tape or blade that may be supported in the housing on a rotating reel. A spring may be located in the housing 1 for automatically rewinding the tape or blade back into the housing on the reel. The spring is arranged to store energy as the tape or blade is unwound from the housing and to use the stored energy to rewind the tape or blade onto the reel if no opposing forces are acting on the tape. The tape or blade may include a steel blade, a plastic or fiberglass ribbon or other relatively flexible material that can be wound on the reel and includes measurement indicia formed thereon as is known. An end hook may be formed at the distal end of the tape or blade to facilitate the temporary attachment of the tape or blade measure to an object during use and to prevent the tape from being completely rewound within the housing. A locking mechanism may be provided that comprises a finger actuator button located on the housing that, when actuated, moves a lock mechanism from an unlocked position to a locked position where the lock mechanism is forced into engagement with tape or blade. The engagement of lock mechanism with tape or blade resists the return force of the return spring to lock the tape or blade in a desired extended position.

### SUMMARY OF THE INVENTION

In some embodiments, tape measure comprises a housing and a blade retractably mounted in the housing such that an end of the blade may be extended from the housing. The blade has a profile with a wave shape.

The wave shape may comprise a peak located adjacent each of a longitudinal edge of the blade and a trough located between the peaks. The peaks may be formed slightly toward a centerline of the blade from the longitudinal edges such that the blade dips toward a trough from the peaks to the longitudinal edges. The trough may be located midway between the two peaks. The profile may be a smooth sinusoidal curve where the blade transitions smoothly from the peaks to the trough. The blade may have a width of approximately one inch. The profile of the blade may have an area in the range of approximately 0.006-0.007 in². The thickness of the blade may be approximately 0.005-0.006 inches. The overall height of the blade between the peaks and the trough may be in the range of approximately 0.2 to 0.3 inches. The transition between the peaks and the trough may be a neutral horizontal axis of the blade and may be positioned a distance approximately 0.103-0.143 inches from a top of the peaks. The second moment of the area may be in the range of approximately 0.0000407 to 0.00006 in⁴. The neutral axis may be approximately 40-50% of the height from a top of the peaks. The wave profile may extend from the end of the blade for a length equal to or greater than a desired standout of the blade. The wave profile may extend from the end of the blade for at least 12 feet. The wave profile may be provided from a point along the blade spaced from the end of the blade and a second point along the length of the blade.

In some embodiments, a tape measure comprises a housing and a blade retractably mounted in the housing such that an end of the blade may be extended from the housing. A sleeve is mounted over the blade to reinforce the blade.

The sleeve may be made of a transparent material. The sleeve may be made of nylon.

In some embodiments, a tape measure comprises a housing and a blade retractably mounted in the housing such that an end of the blade may be extended from the housing. A reinforcement member is attached to the blade over a length of the blade.

The reinforcement member may extend from the end of the blade for a length equal to or greater than a desired standout of the blade. The reinforcement member may extend from the end of the blade for at least 12 feet. The reinforcement member may be provided from a point along the blade spaced from the end of the blade and a second point along the length of the blade. The blade may have a profile and the reinforcement member may have a complimentary profile over at least a portion of a width of the blade. A dimension of the reinforcement member may vary over the length of the blade. The reinforcement member may be attached to the blade using a plastic sleeve. The reinforcement member may be attached to the blade using a nylon sleeve. The reinforcement member may abut against a surface of the blade along the entire length and width of the reinforcement member.

### BRIEF DESCRIPTION OF THE DRAWINGS

FIG. 1 is a perspective view of an embodiment of the tape measure of the invention.

FIG. 2 is a top view of the tape measure of FIG. 1.

FIG. 3 is a front view of the tape measure of FIG. 1.

FIG. 4 is an end view showing the profile of the blade used in the tape measure of FIG. 1.

FIG. 5 is a perspective view of a section of the blade of FIG. 4.

FIG. 6 is a bottom perspective view of the tape measure of FIG. 1.

FIGS. 7, 8 and 9 are end views showing alternate profiles of the blade.

FIG. 10 is a perspective view of an alternate embodiment of the tape measure of FIG. 1.

FIG. 11 is a perspective view of another alternate embodiment of the tape measure of FIG. 1.

FIG. 12 is a perspective view of an alternate embodiment of the tape measure of the invention.

FIG. 13 is a bottom perspective view of the tape measure of FIG. 12.

FIG. 14 is a side view of the tape measure of FIG. 12.

FIG. 15 is a perspective view of an alternate embodiment of the tape measure of the invention.

FIG. 16 is a bottom perspective view of the tape measure of FIG. 15.

FIG. 17 is a perspective view of an alternate embodiment of the tape measure of FIG. 15.

FIG. 18 is a bottom perspective view of an alternate embodiment of the tape measure of the invention.

FIG. 19 is a bottom perspective view of an alternate embodiment of the tape measure of the invention.

FIG. 20 is a side view of an alternate embodiment of the tape measure of the invention.

FIG. 21 is a side view of an alternate embodiment of the tape measure of the invention.

FIG. 22 is a side view of an alternate embodiment of the tape measure of the invention.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

Relative terms such as “below” or “above” or “upper” or “lower” or “horizontal” or “vertical” or “top” or “bottom” may be used herein to describe a relationship of one element, component or region to another element, component or region as illustrated in the figures. It will be understood that these terms are intended to encompass different orientations of the device in addition to the orientation depicted in the figures.

Referring to the Figures, one embodiment of a tape measure comprises a housing 1. The housing 1 defines an interior space for receiving the tape or blade 2 that may be supported in the interior space on a rotating reel or spool. An opening 8 is formed in the front of housing 1 that receives the tape or blade 2 and allows the tape or blade to pass into and out of the housing 1. A spring may be located in the housing 1 for automatically rewinding the tape or blade 2 back into the housing 1 on the reel. The spring is arranged to store energy as the tape or blade 2 is manually unwound from the housing and to use the stored energy to rewind the tape or blade 2 on the reel if no opposing forces are acting on the tape or blade 2. While one embodiment of a take-up mechanism has been described it will be appreciated that numerous changes may be made in the construction of the tape measure. For example, in some embodiments the tape or blade 2 may be extended and/or retracted using a battery operated motor rather than the take-up spring. In other embodiments the tape or blade may be retracted and extended manually. Other variations in the details of the tape take-up mechanism are also possible. A locking mechanism may also supported on housing 1 and includes a finger actuator button 10 located in an opening 12 in the housing 1. When the actuator button 10 is depressed, a lock mechanism 14 is moved from an unlocked position to a locked position where the lock mechanism 14 is forced into engagement with blade 2. The engagement of lock mechanism 14 with blade 2 resists the return force of the return spring to lock the blade 2 in a desired extended position. One suitable mechanism for extending and retracting the tape or blade is disclosed in U.S. Pat. No. 7,377,050 issued on May 27, 2008 to Shute et al. and assigned to Irwin Industrial Tool Company which is incorporated by reference herein in its entirety.

Tape or blade 2 may include a steel blade, a composite blade, a plastic or fiberglass ribbon or other relatively flexible material that can be wound on the reel. The tape or blade will be referred hereinafter as a “blade”. In one preferred embodiment the blade is made of steel or other similar material that has some structural rigidity such that the blade, when extended from the housing, does not collapse. The distance the blade can extend from the housing without collapsing is referred to as “standout.” Blade 2 includes measurement indicia 3 formed thereon as is known. In some embodiments the measurement indicia 3 may be formed on the top surface 2a and/or the bottom surface 2b of the tape. The measurement indicia 3 may comprise English units, metric units, a combination of different units or other units. Blade 2 may include an end hook 4 at the distal end thereof to facilitate the temporary attachment of the tape measure to an object during use of the tape measure and to prevent the blade 2 from being completely rewound within the housing 1.

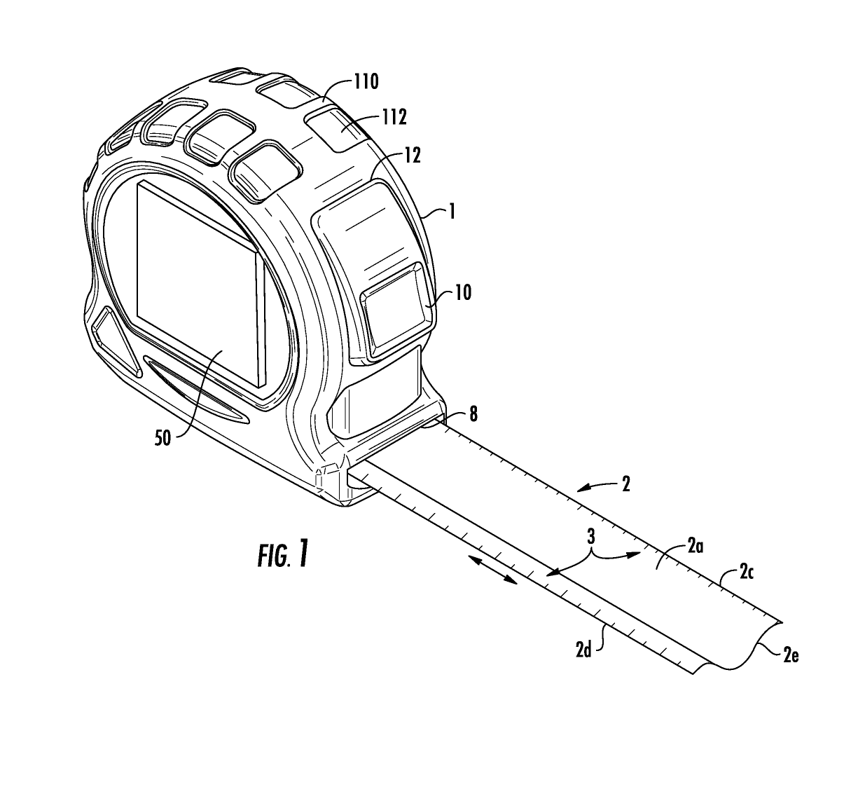

Referring to FIG. 1 in one embodiment the blade 2 is formed to have a standout and may have a greater than 12 foot standout and in one embodiment may have up to a 16 foot standout. A long standout is desirable because it allows the user to extend the blade 2 greater distances to reach remote objects. In one embodiment the standout is provided by forming the blade 2 to have a complex curve shaped profile or cross-section. In cross-section the blade 2 may have a profile, for at least the distance of the desired standout, where portions of the blade across the width of the blade extend at a plurality of angles to provide rigidity to the blade.

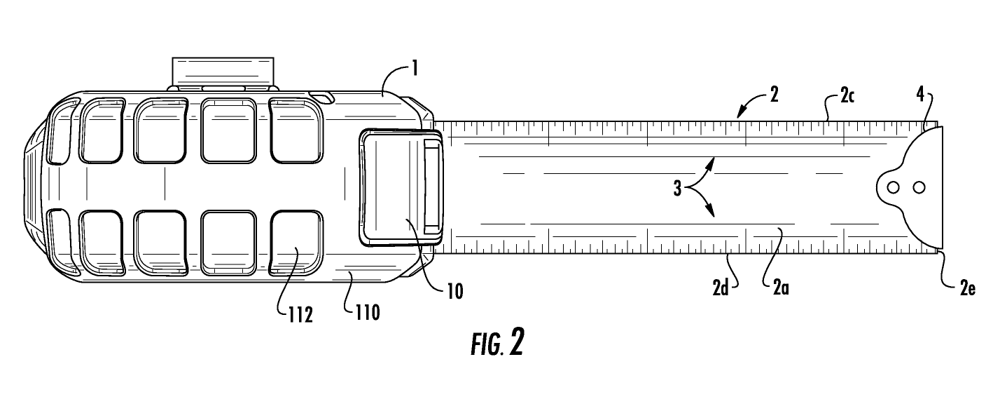

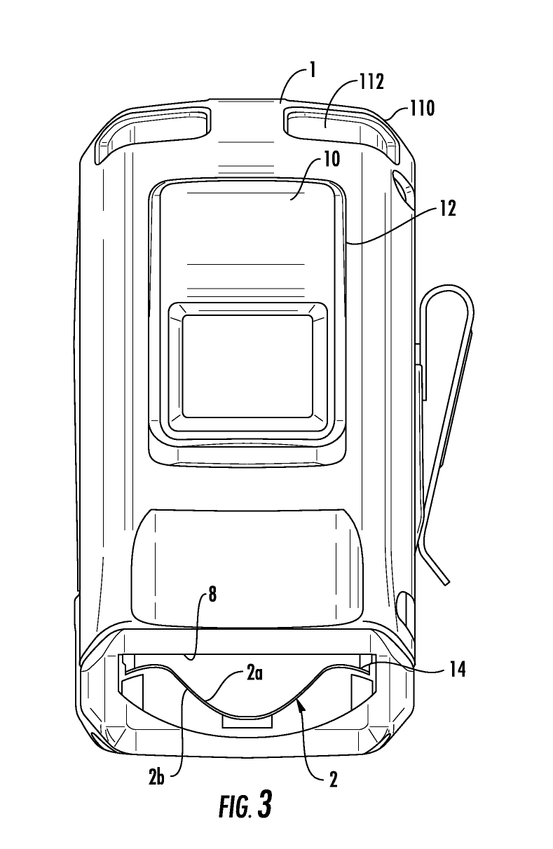

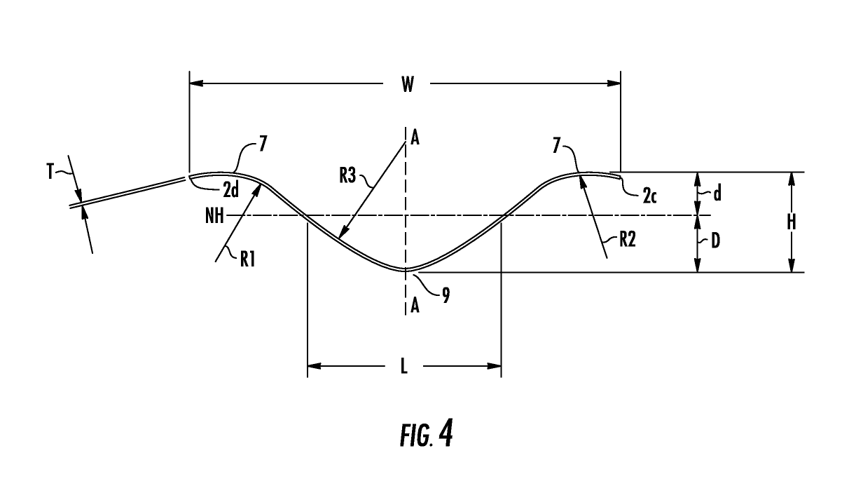

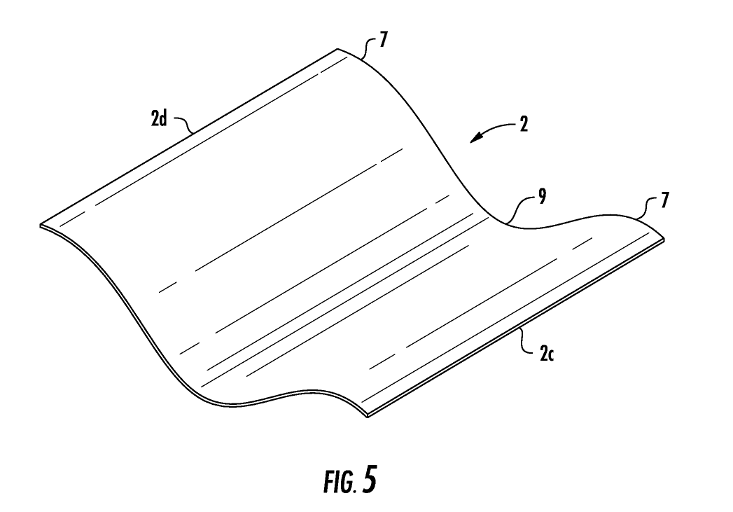

Referring to FIGS. 1-7, in one embodiment the profile or cross-section of the blade 2 has a complex curve or wave profile. The wave profile may be similar to a sine wave shape or sinusoidal shape where the profile includes one or more peaks and one or more troughs across the width of the blade. The wave profile may be a smooth curve having rounded transitions or it may be an angular shape having angled transitions. Blade profiles having smooth curves with rounded transitions, straight segments connected at corners and combinations of smooth curves and straight segments are referred to herein as wave profiles and complex curve profiles. In one embodiment of the blade 2, the blade 2 has a peak 7 located adjacent each of the longitudinal edges 2c and 2d of the blade and a trough 9 located midway between the two peaks 7. It is to be understood that the blade 2 may be turned upside down relative to the housing 1 such that the peaks 7 may be considered troughs and the trough 9 may be considered a peak. Moreover, in use the tape measure may be used in any orientation. The blade 2 is described as having a wave or sinusoidal profile; however, the blade 2 does not necessarily conform exactly to the shape of a mathematical sine wave. The blade is formed with two peaks 7 one peak being located adjacent each of the longitudinal edges 2c, 2d of the blade 2. The peaks 7 are formed slightly toward the centerline of the blade 2 from the edges 2c, 2d such that the blade begins to dip toward a trough from the peaks 7 to the edges 2c, 2d of the blade 2. A trough 9 is located between the two peaks and is positioned generally at the longitudinal center line of the blade 2. The profile of the blade 2 is a smooth curve such that the blade transitions smoothly from the convex curves that form the peaks 7 to the concave curve that forms the trough 9. In one embodiment the blade has a width W of approximately 1 inch although the width of the blade may be different for different size tape measures. The width of the one inch blade may vary slightly from 1 inch due to manufacturing tolerances and the like. For a nominal 1 inch width blade the flat width of the blade may be approximately 1.23 inches. For a nominal 1 inch blade, the profile or cross-section of the blade may have an area of approximately 0.00615-0.00671 in² or in the range of approximately 0.006-0.007 in². For a one inch blade the thickness T of the blade may be approximately 0.005-0.006 inches. For a one inch blade the overall height H between the peaks 7 of the blade and the trough 9 of the blade may be approximately 0.22-0.237 inches or in the range of approximately 0.2 to 0.3 inches. The radius of the peaks 7 R1, R2 is approximately 0.331 in. and the radius of the trough R3 is approximately 0.337-0.385 in. The linear length L of the trough 9 is approximately 0.5-0.6 in. The transition between the convex curves that form peaks and the concave curve that forms the trough is the neutral horizontal axis of the blade NH and is positioned a distance d approximately 0.103-0.143 inches from the top of the peaks 7 and a distance D approximately 0.111-0.134 inches from the bottom peaks. NH represents the neutral axis line through the centroid for bending in the standout “droop” direction (about the horizontal axis). The neutral axis is the line where the compressive stress in the bottom of the section (below the NH-Axis) transitions to tension stress in the top of the section (above the NH-Axis) when the section is being stressed in bending down, such as when drooping under its own weight. For material with the same modulus of elasticity in compression and tension the neutral axis NH is at the centroid and has zero stress due to pure bending. The centroid is the balance point of the section. Ixx is the Second Moment of the Area (also known as the Moment of Inertia) about the NH-Axis. This property of the cross-section area is directly related to the stiffness of the section in bending about the -XX-Axis. The Ixx for the disclosed blade is approximately 0.000042 in⁴ or in the range of approximately 0.0000407 and 0.0000538 in⁴ or in the range of approximately 0.0000407 to 0.00006 in⁴.

In some embodiments the width W may be approximately 3 to 5.5 times the height. Moreover the neutral axis NH may be approximately 40-50% of the height from the top of the peaks 7. While a blade profile having two peaks 7 and one trough 9 is described it will be appreciated that the pattern may be repeated such that more than the illustrated peaks and troughs are provided. Moreover, the blade may not be symmetrical about axis A-A.

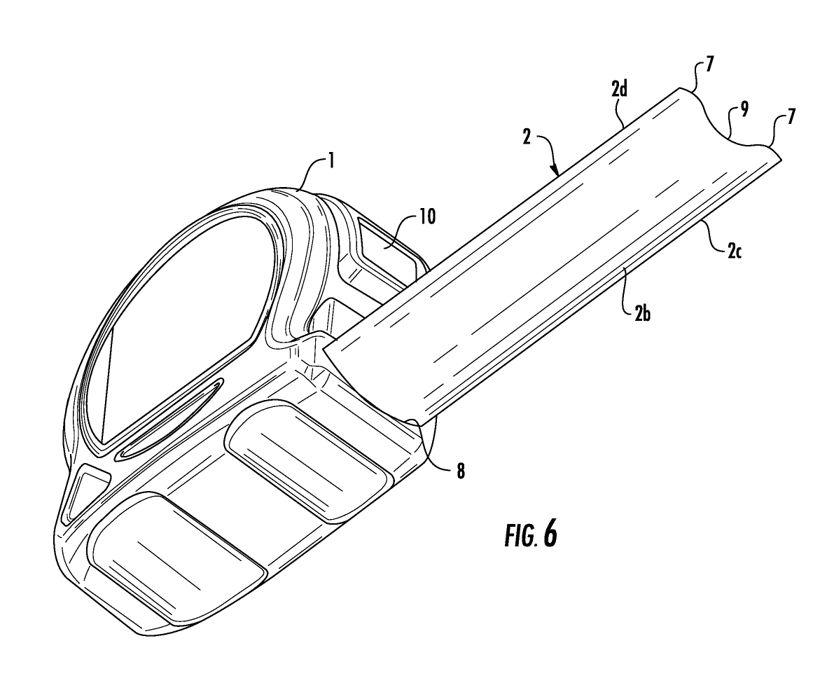

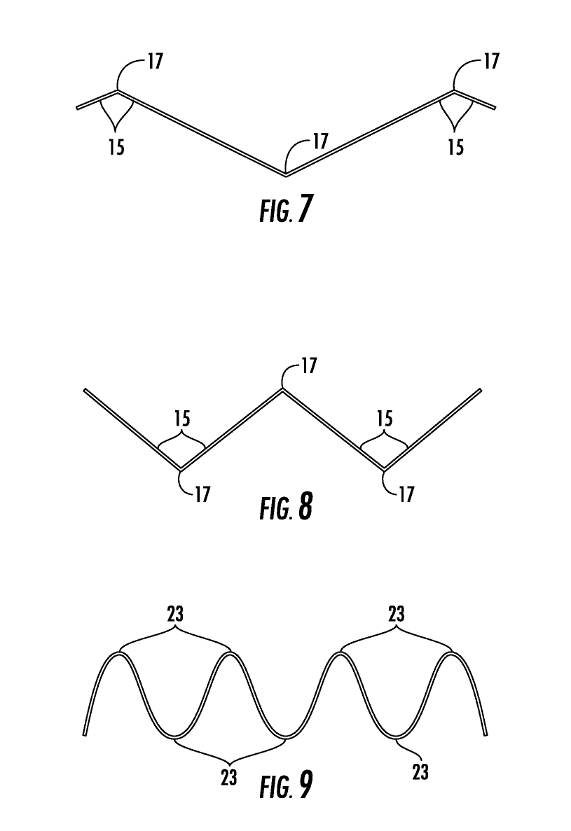

In other embodiments the blade 2 may be provided with other wave profiles such as the profile shown in FIG. 7 which is similar to the profile of FIG. 4 except that rather than smooth curves, the blade profile is formed of straight segments 15 connected at corners 17. FIG. 8 shows a blade having straight segments 15 connected at corners 17 and formed in a W-shaped profile. FIG. 9 shows a blade having a wave profile that is formed as a rippled or serrated profile where a plurality of ridges 23 are formed over the width of the blade.

The complex curved wave profile extends over at least a determined length of the blade. In one embodiment the complex curve may extend for the entire length of the blade. In one embodiment the complex curved profile extends from the end 2e of the blade for a length equal to or greater than the desired standout of the blade as shown in FIG. 10. For example, if a blade with a 16 foot standout is desired the complex curved profile may extend from the exposed end 2e of the blade to a point P that is a distance of at least 16 feet. For example, for a 16 foot standout the end of curved profile point P may be 17 feet from the end 2e of blade 2. From point P to the opposite end of the blade (attached to the reel inside of housing 1) the blade 2 may be provided with a simple profile shape such as flat, a convex curve or concave curve.

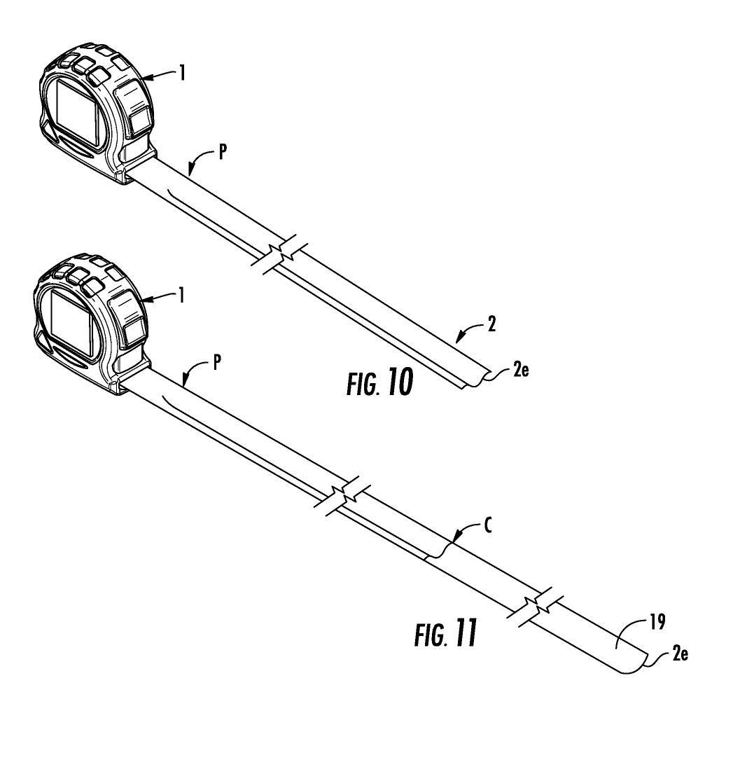

In some embodiments it is not necessary to extend the wave profile from the end 2e of the blade 2. For example, the blade 2 without any additional reinforcement may have a certain natural standout due to the rigidity of the material and/or the simple curved shape of the blade, e.g. a simple concave curve profile; however, the natural standout may be less than the desired standout. Referring to FIG. 11, the complex curved wave profile described herein may be provided from a point C on the blade 2 near where the natural standout of the blade ends and the desired standout. For example, assuming a blade has a natural standout of 8 feet due to the rigidity of the material and the simple concave curve 19 but the desired standout is 12 feet, the complex curved profile may extend from point C that is approximately 8 feet or less from the end 2e of the blade, e.g. 7 feet, to a point P at or beyond the desired standout of 12 feet, e.g. 13 feet. From point P to the opposite end of the blade, the blade 2 may be provided with a simple profile shape such as flat, a convex curve or concave curve. In this manner the complex curved wave profile may only be used in the area of the blade where the blade is likely to collapse and where collapse of the blade is not desired.

Because the blade 2 is made of a relatively resilient material, when the blade is retracted and wound on the reel in housing 1 the blade will flex into a relatively flat shape such that the blade can wind on itself in a relatively small diameter spool.

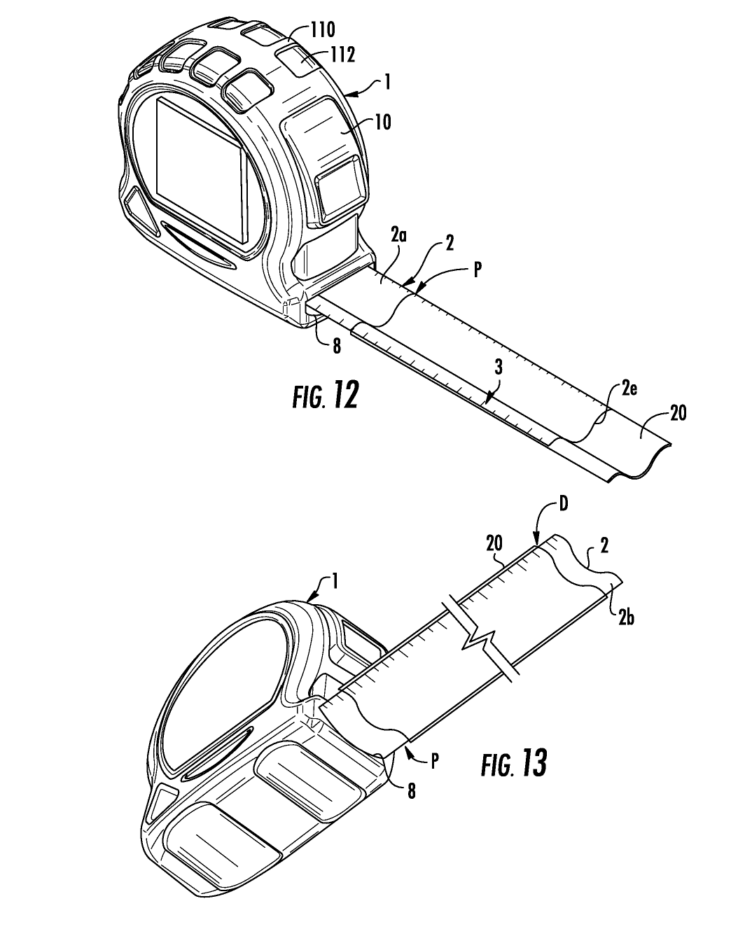

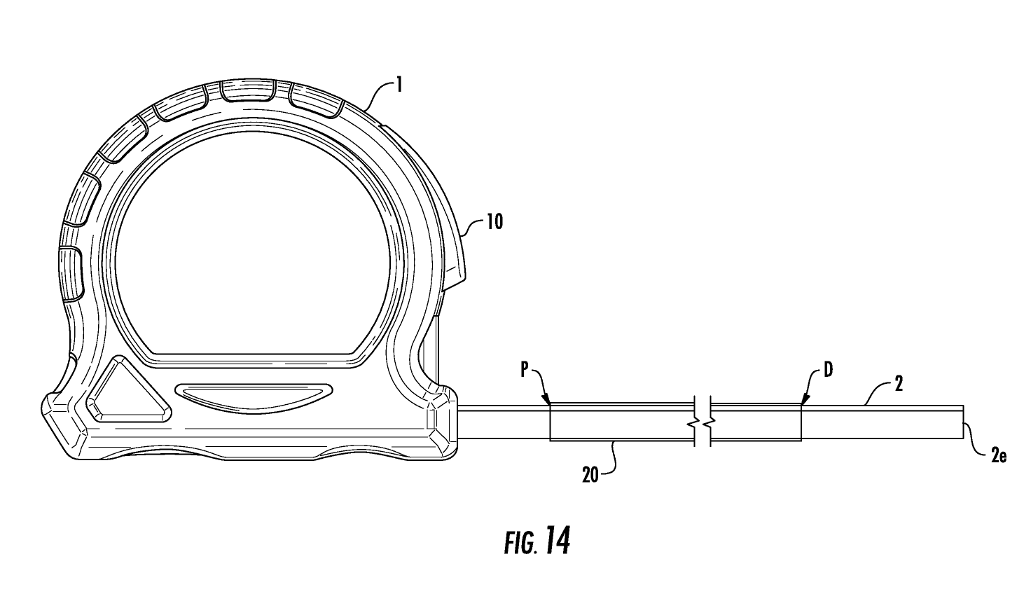

Improved standout may also be provided using a sleeve 20 over the blade 2 where the sleeve 20 extends the desired standout length from the end of the tape as shown in FIGS. 12 through 14. In FIG. 12 the sleeve 20 is shown extending beyond the end of the blade 2 to illustrate the relationship between the sleeve 20 and the blade 2. In an actual tape measure the sleeve 20 is coextensive with the blade 2 over the entire length of the sleeve and for at least a determined length of the blade. In one embodiment the sleeve extends from the end of the blade 2e to a point P that is a distance from the end of the blade equal to or greater than the desired standout of the blade. For example, if a blade with a 12 foot standout is desired the sleeve may extend from the exposed end 2e of the blade a distance of at least 12 feet. For example for a 12 foot standout the sleeve may extend for 13 feet. In some embodiments it is not necessary to extend the sleeve from the end 2e of the blade. For example, the blade 2 without any additional reinforcement may have a certain natural standout due to the rigidity of the material and/or the shape of the blade; however, the standout may be less than desired. The sleeve may be provided from a point D on the blade near where the natural standout of the blade ends and the desired standout at point P as shown in FIG. 13. In this manner the length of reinforcement sleeve used is reduced thereby reducing the overall weight and size of the tape measure. The sleeve 20 may be transparent and may comprise a relatively thick layer of nylon or other suitable material that allows the indicia printed on the blade 2 to be visible through the sleeve 20. In some embodiments an opaque sleeve may be used and the indicia may be printed on the sleeve. Where the sleeve includes the indicia, the indicia on the sleeve must be aligned with and form part of the scale with the indicia on the blade. The sleeve 20 may completely surround the blade 2 and may have a thickness that provides the necessary rigidity to achieve the desired standout. While the sleeve 20 may be used with a blade 2 having the complex curve wave profile shapes described herein the sleeve 20 may be used separately from the shapes described herein such that a blade using the sleeve 20 may have a simple convex or concave shape or other shapes.

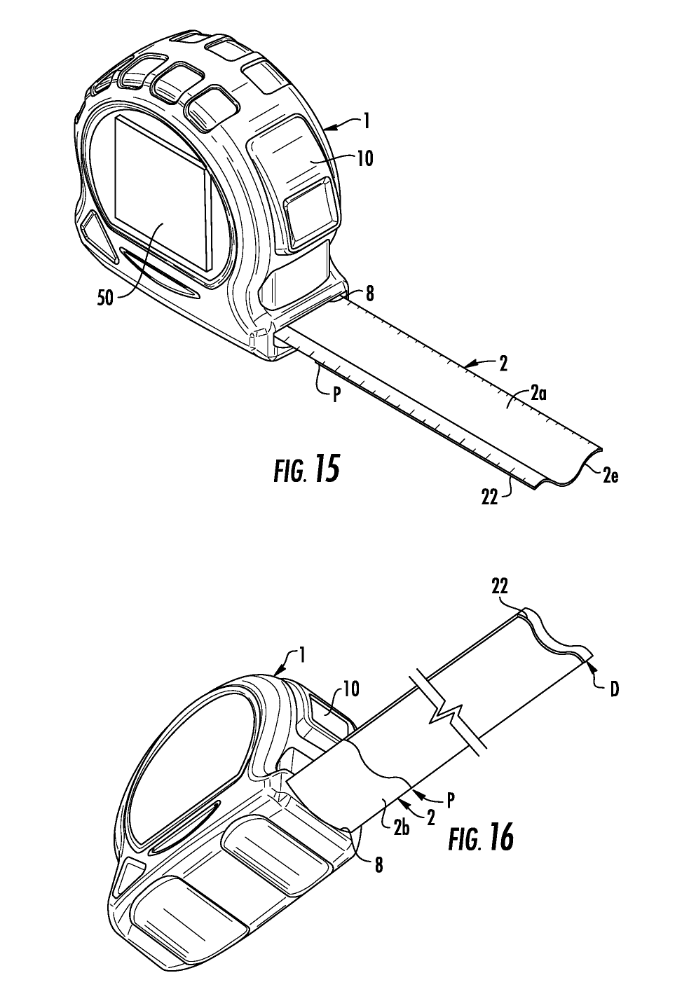

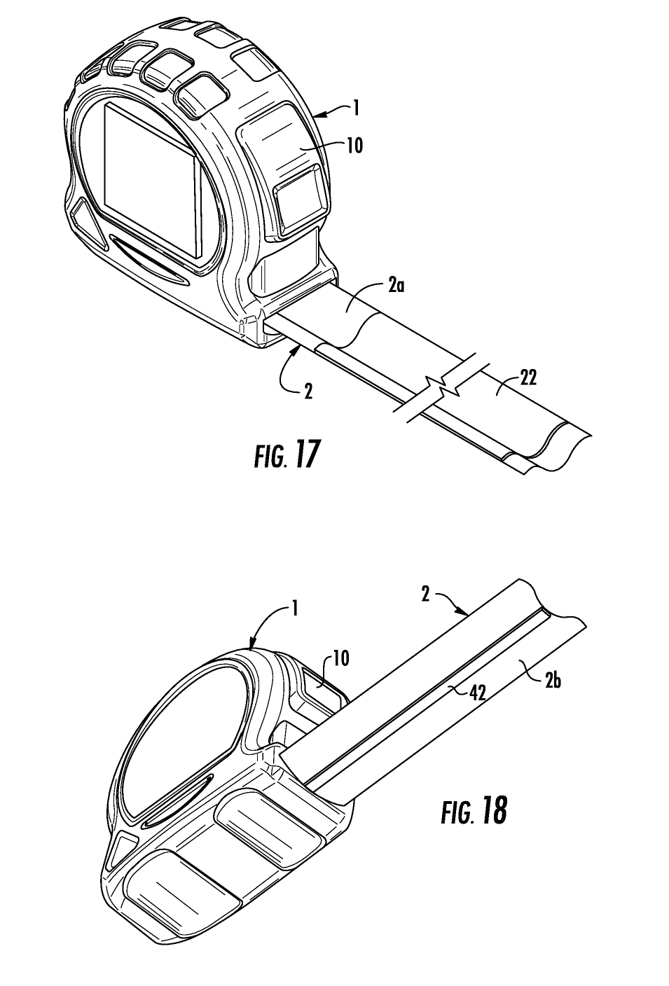

Referring to FIGS. 15 and 16, in some embodiments a reinforcement member may be attached to the blade 2 where the reinforcement member 22 may comprise a member made of the same or similar material to that of the blade 2. For example, the reinforcement member 22 may be made of steel such as the steel that forms the blade 2. While in some embodiments the material of the blade 2 and the reinforcement member 22 may be the same the materials may be different. For example, the blade 2 may be made of steel and the reinforcement member 22 may be made of a composite material. Referring to FIGS. 15 and 16, the reinforcement member 22 may be applied to the bottom face 2b of the blade 2 and may have the same profile shape as the profile shape of the blade 2. For example the blade 2 may have the shape described with reference to FIGS. 1-10 and the reinforcement member 22 may have a complimentary shape. Because the reinforcement member 22 is applied to the bottom face 2b of the blade 2 the dimensions of the reinforcement member 22 may be determined such that the top face of the reinforcement member 22 abuts the bottom face 2b of the blade 2 over the length and width of the reinforcement member 22. While the reinforcement member 22 may be used with a blade 2 having the profile shapes described herein the reinforcement member 22 may be used separately from the shapes described herein such that a blade using the reinforcement member 22 may have a simple convex or concave shape or other shapes. Where the blade has a simple curved profile the reinforcement member 22 will have a similar complimentary simple curved profile. The reinforcement member 22 may also be applied to the top face 2a of the blade 2 as shown in FIG. 17. In other embodiments the reinforcement member 22 may be formed as a sleeve where the blade 2 fits inside of the sleeve such that the sleeve covers all sides of the blade 2.

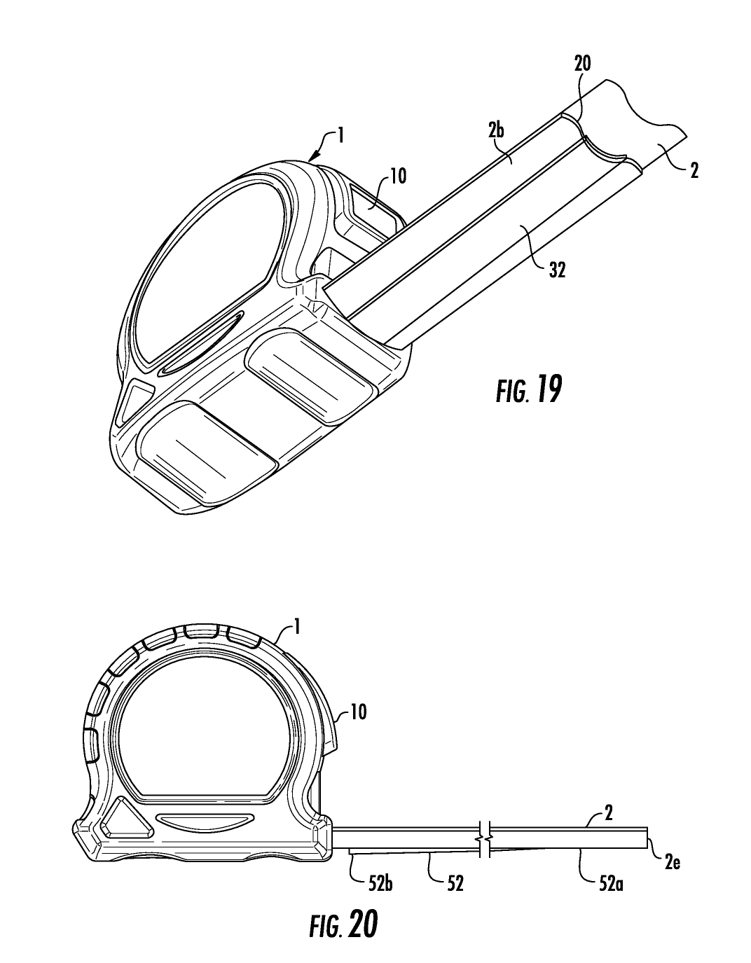

Referring to FIGS. 18 and 19, in some embodiments the reinforcement member may not have the same shape as the blade. For example, as shown in FIG. 19 the reinforcement member 32 may have a complementary shape over a portion of the width of the blade 2 but the reinforcement member 32 may not extend for the full width of the blade 2. In FIG. 19 the reinforcement member is secured to the bottom face 2b of blade 2 but in other embodiments the reinforcement member may be secured to the top face 2a of blade 2. In other embodiments the reinforcement member 42 may have a shape that is not necessarily complimentary to the shape of the blade 2 where, for example, the reinforcement member 42 may be formed as a thin flat strip, rod, tube or the like that extends along the length of the blade 2 as shown in FIG. 18. In FIG. 18 the reinforcement member 42 is secured to the bottom face 2b of blade 2 but in other embodiments the reinforcement member 42 may be secured to the top face 2a of blade 2. In the embodiments of FIGS. 18 and 19 the reinforcement members 32, 42 may extend from the end 2e of the blade 2 to a point P or the reinforcement members may extend from a point D spaced from the end of the blade 2 to point P as previously described.

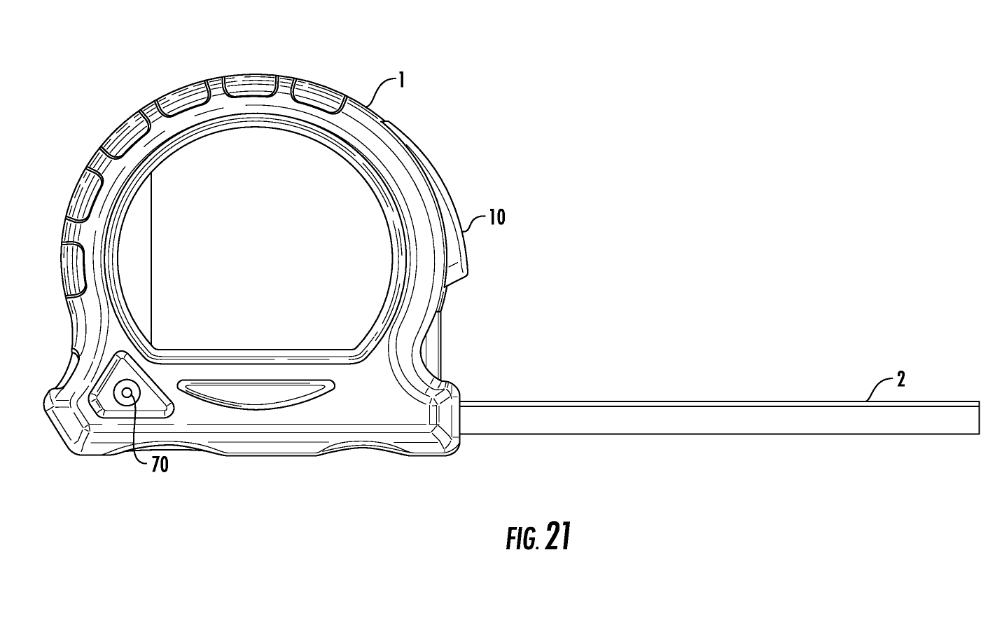

The reinforcement members 22, 32 and 42 may have the same thickness as the blade, a thinner thickness or a greater thickness depending upon the amount of reinforcement required. Moreover a dimension of the reinforcement member such as the thickness and/or width of the reinforcement member may vary over the length of the blade. For example, as shown in FIG. 20 the reinforcement member 52 may have a thinnest thickness at the end 52a closer to the end 2e of the blade 2 and the thickness of the reinforcement member may increase over the length of the reinforcement member 52 to the opposite end 52b to increase the amount of reinforcement provided as the standout length increases. The width of the reinforcement member may also increase over the length of the blade in addition to or in place of increasing the thickness. Other arrangements may be provided for increasing the resistance to bending of the reinforcement member over the length of the reinforcement member from the free end of the blade. A reinforcement member having an increasing thickness or width may be used with any of the embodiments described herein.

The reinforcement members as described herein may be attached to the blade using any suitable mechanism. In one embodiment the reinforcement member may be attached to the blade using a sleeve 20 such as the nylon sleeve described with reference to FIGS. 12 and 13 where the sleeve 20 is applied over the blade 2 and the reinforcement member 22, 32, 42, 52 as shown for example in FIG. 19. In other embodiments, the reinforcement member may be attached to the blade 2 using adhesive, welding, mechanical attachments or the like. The reinforcement member may be attached to the blade using a combination of mechanisms and devices. In some embodiments the attachment mechanism preferably holds the surface of the reinforcement member against the surface of the blade along the length and width of the reinforcement member.

Because the reinforcement member is not necessarily made of a transparent material, the reinforcement member may be attached to the blade before the indicia 3 is printed on the blade 2. In this manner the indicia 3 may be printed over the reinforcement member and the blade in a single operation.

Referring to FIGS. 1, 2 and 3, a shock-absorbing sleeve 110 may be provided over a plastic casing 112 to form housing 1. Sleeve 110 may be made of aluminum or other rigid reinforcing material that protects the housing 1 which may be made of, for example, plastic.

Still referring to FIG. 1 the housing 1 may be provided with an easily erasable writing surface 50 that allows the user to temporarily store information such as measurements. The writing surface 50 may be permanently fixed to the housing 1. In some embodiments the surface 50 may comprise a transitory touch sensitive pad such as a gel pad, magnetic board, aluminum powder board or the like. In other embodiments the writing surface may comprise a surface such as a white board, slate, or the like. In a preferred embodiment the writing surface 50 may comprise any surface that may be written on using a pencil such as is commonly used by tradesmen where the writing is transitory and may be easily removed.

FIG. 21 shows another embodiment of a tape measure where an air brake is provided to slow the retraction of the tape. The air brake uses air pressure against the rotating reel to slow movement of the reel during retraction. The reel may move the air through a restricted opening 70 such that the air back pressure retards or slows the speed of rotation of the reel. Other air braking systems may also be used.

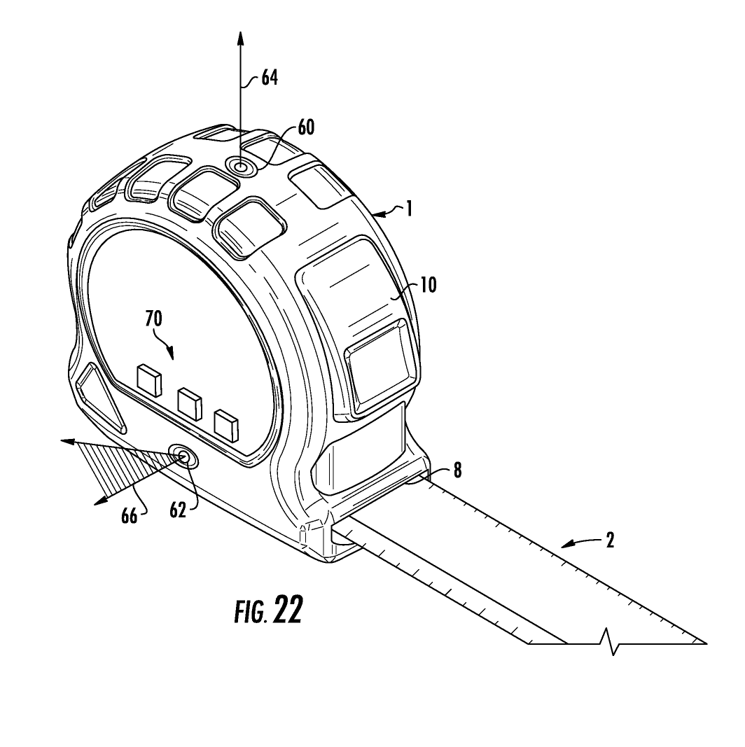

FIG. 22 shows still another embodiment of a tape measure having laser pointers 60, 62 mounted in the housing 1 for developing laser lines or laser points 64, 66 that may be used for layout, measurement or the like. The lasers 60, 62 may be battery operated to provide a mobile device. In one embodiment two laser lines 64, 66 are generated as shown in FIG. 22 although a greater or fewer number of lasers and laser lines may be provided. The laser lines 64, 66 may be provided in a tightly controlled beam (line 64) such that the lasers create a dot of light on a surface that is perpendicular to the laser. Alternatively, the laser lines may be fan shaped (line 66) where the laser lines create a line of light on a surface. Other types of laser lines may be used. In one embodiment the two laser lines 64, 66 may be orthogonal to one another as shown to define x, y axes. In some embodiments three orthogonal lines may be provided defining x, y and z axes. Multiple lines having other spatial relationships may also be provided. Moreover, a single laser line may be provided. Suitable controls 70 may be provided on the housing 1 for controlling the activation of the lasers.

Although specific embodiments have been shown and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

1. A tape measure comprising:
a housing;
a blade retractably mounted in the housing such that an end of the blade may be extended from the housing;
the blade having a profile with a wave shape.

2. The tape measure of claim 1 wherein the wave shape comprises a peak located adjacent each of a longitudinal edge of the blade and a trough located between the peaks.

3. The tape measure of claim 1 wherein the peaks are formed slightly toward a centerline of the blade from the longitudinal edges such that the blade dips toward a trough from the peaks to the longitudinal edges.

4. The tape measure of claim 1 wherein the trough is located midway between the two peaks.

5. The tape measure of claim 1 wherein the profile is a smooth sinusoidal curve where the blade transitions smoothly from the peaks to the trough.

6. The tape measure of claim 1 wherein the blade has a width of approximately one inch.

7. The tape measure of claim 1 wherein the profile of the blade has an area in the range of approximately 0.006-0.007 in².

8. The tape measure of claim 1 wherein the thickness of the blade is approximately 0.005-0.006 inches.

9. The tape measure of claim 1 wherein the overall height of the blade between the peaks and the trough is in the range of approximately 0.2 to 0.3 inches.

10. The tape measure of claim 1 wherein the transition between the peaks and the trough is a neutral horizontal axis of the blade and is positioned a distance approximately 0.103-0.143 inches from a top of the peaks.

11. The tape measure of claim 1 wherein the second moment of the area is in the range of approximately 0.0000407 to 0.00006 in⁴.

12. The tape measure of claim 1 wherein the neutral axis is approximately 40-50% of the height from a top of the peaks.

13. The tape measure of claim 1 wherein the wave profile extends from the end of the blade for a length equal to or greater than a desired standout of the blade.

14. The tape measure of claim 1 wherein the wave profile extends from the end of the blade for at least 12 feet.

15. The tape measure of claim 1 wherein the wave profile is provided from a point along the blade spaced from the end of the blade and a second point along the length of the blade.

16. A tape measure comprising:
a housing;
a blade retractably mounted in the housing such that an end of the blade may be extended from the housing;
a sleeve over the blade.

17. The tape measure of claim 16 wherein the sleeve is made of a transparent material.

18. The tape measure of claim 16 wherein the sleeve is made of nylon.

19. A tape measure comprising:
a housing;
a blade retractably mounted in the housing such that an end of the blade may be extended from the housing;
a reinforcement member attached to the blade over a length of the blade.

20. The tape measure of claim 19 wherein the reinforcement member extends from the end of the blade for a length equal to or greater than a desired standout of the blade.

21. The tape measure of claim 19 wherein the reinforcement member extends from the end of the blade for at least 12 feet.

22. The tape measure of claim 19 wherein the reinforcement member is provided from a point along the blade spaced from the end of the blade and a second point along the length of the blade.

23. The tape measure of claim 19 wherein the blade has a profile and the reinforcement member has a complimentary profile over at least a portion of a width of the blade.

24. The tape measure of claim 19 wherein a dimension of the reinforcement member varies over the length of the blade.

25. The tape measure of claim 19 wherein the reinforcement member is attached to the blade using a plastic sleeve.

26. The tape measure of claim 19 wherein the reinforcement member is attached to the blade using a nylon sleeve.

27. The tape measure of claim 19 wherein the reinforcement member abuts against a surface of the blade along the entire length and width of the reinforcement member.
